(19) United States
(12) Patent Application Publication
(10) Pub. No.: US 2017/0100218 A1
(43) Pub. Date: Apr. 13, 2017

(54) Dental Framework

(71) Applicants: Volodymyr Kuzmin, Hamilton, NJ (US); Jaloliddin Nuriddinov, Philadelphia, PA (US)

(72) Inventors: Volodymyr Kuzmin, Hamilton, NJ (US); Jaloliddin Nuriddinov, Philadelphia, PA (US)

(21) Appl. No.: 14/881,691

(22) Filed: Oct. 13, 2015

(51) Int. Cl. A61C 8/00

(52) U.S. Cl. CPC A61C 8/0027; A61C 8/0075; A61C 8/0028; A61C 8/0043

(57) ABSTRACT

A dental framework has an integral body with an elongated, serpentine shape framework support extending substantially the length of the body. Uniquely designed dental crown receiving abutments each have a lower section with a larger average diameter than an upper section. This creates an adhesive receiving space between the abutments and the dental crowns which are installed on them. The abutments are also positioned such that gum composite material utilized following the installation of the framework and dental crowns can be inserted between adjacent abutments and the crowns to enhance the ultimate appearance of the mouth. A series of composite attaching spikes extend downward from the framework to ensure the framework remains secured within the composite material which is utilized.

### BACKGROUND OF THE INVENTION

Many dental implant systems and dental prosthetic devices utilize a type of metal skeletal framework which comprises upstanding abutments for receiving dental crowns, bridges, false teeth and the like, and implant supports for fixing such devices within the alveolar jaw of a patient. Such systems, while sometimes partially effective, have a number of disadvantages. For example, there are often difficulties in framework installation, patient fit discomfort, loosening of crowns from the framework, and the loosening of the frameworks themselves from the patient's jaw. Many such devices also do not result in an overall attractive patient appearance.

### SUMMARY OF THE INVENTION

It is thus the object of the present invention to provide a dental framework which overcomes the disadvantages and limitations of existing frameworks, implant systems, and prosthetic devices.

It is the object of the present invention to provide a dental framework which is configured to be secured and permanently maintained within the mouth of the patient.

It is another object of the present invention to provide a dental framework which is fabricated to be sufficiently strong so as to last for the life of the patient.

It is still another object of the present invention to provide a dental framework with dental crown supporting abutments configured to permanently secure dental crowns to the support bar of the dental framework.

It is a further object of the present invention to provide a dental framework which is securely and permanently attached within the mouth of the patient.

It is still another object of the present invention to provide a dental framework which, once installed within the mouth of the patient, results in an appealing and attractive appearance.

These and other objects are accomplished by the present invention, a dental framework comprising an integral body with an elongated, serpentine shape framework support extending substantially the length of the body. Uniquely designed dental crown receiving abutments each have a lower section with a larger average diameter than an upper section. This creates an adhesive receiving space between the abutments and the dental crowns which are installed on them. The abutments are also positioned such that gum composite material utilized following the installation of the framework and dental crowns can be inserted between adjacent abutments and the crowns to enhance the ultimate appearance of the mouth. A series of composite attaching spikes extend downward from the framework to ensure the framework remains secured within the composite material which is utilized.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a top perspective view of the dental framework of the present invention.

FIG. 2 is a bottom perspective view of the dental framework of the present invention.

FIG. 3 is a front view of the dental framework of the present invention.

FIG. 4 is a bottom view of the dental framework of the present invention.

FIG. 5 is a partial front view of the dental framework of the present invention, illustrating the relationship between its support bar, abutments, and dental crowns.

FIG. 6 is a partial front view of the dental framework of the present invention, illustrating the relationship of the gum composite material, as it is used in combination with the dental framework.

FIG. 7 is a partial cross-sectional view of the positioning of a dental crown on an abutment of the dental framework of the present invention.

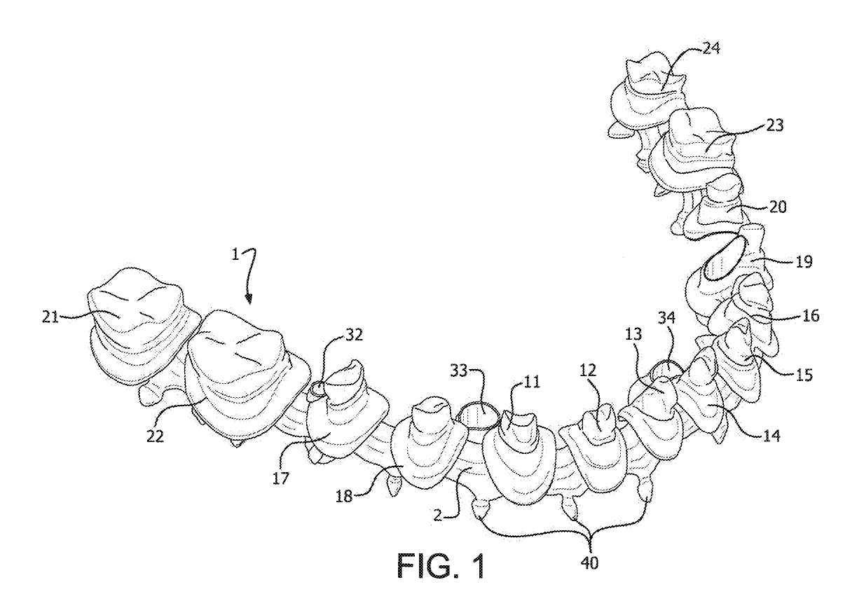

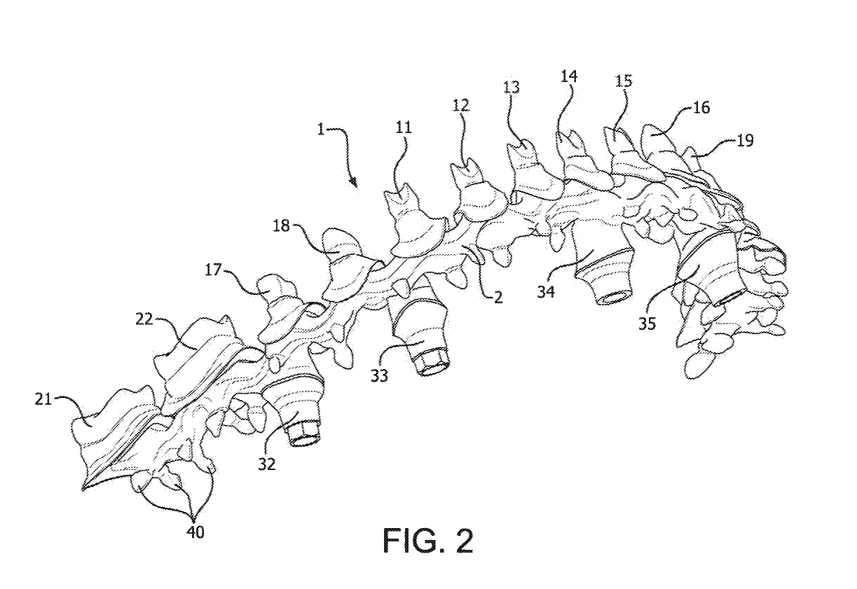

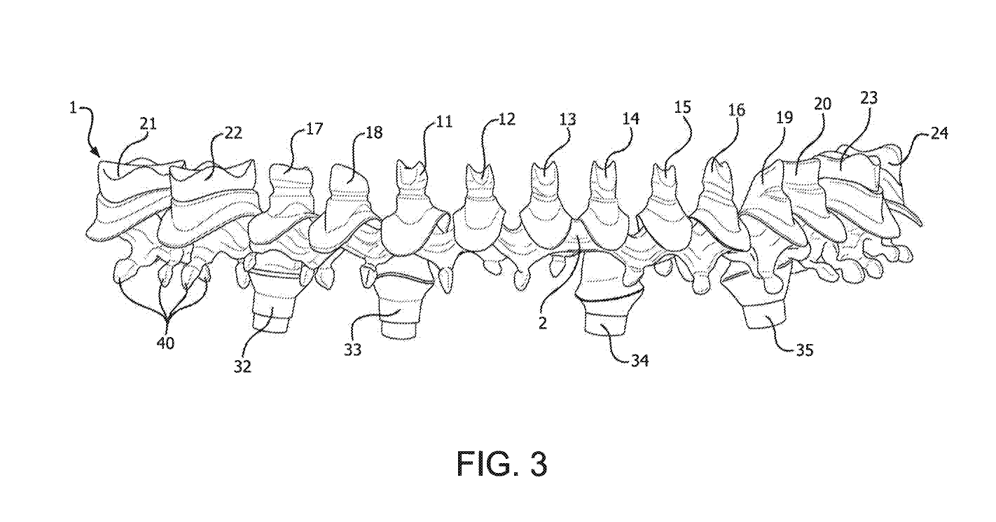

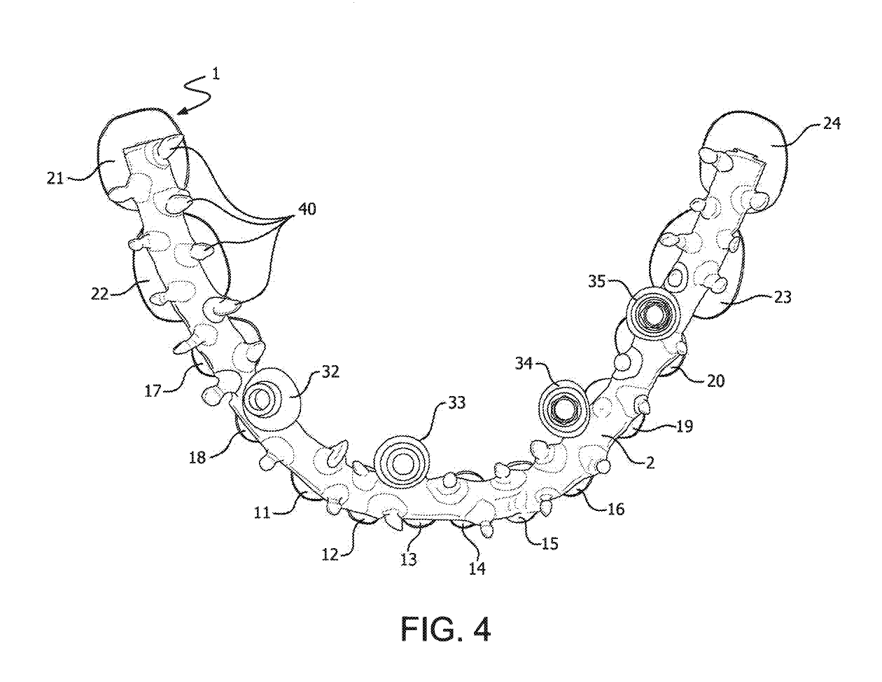

### DETAILED DESCRIPTION OF THE INVENTION

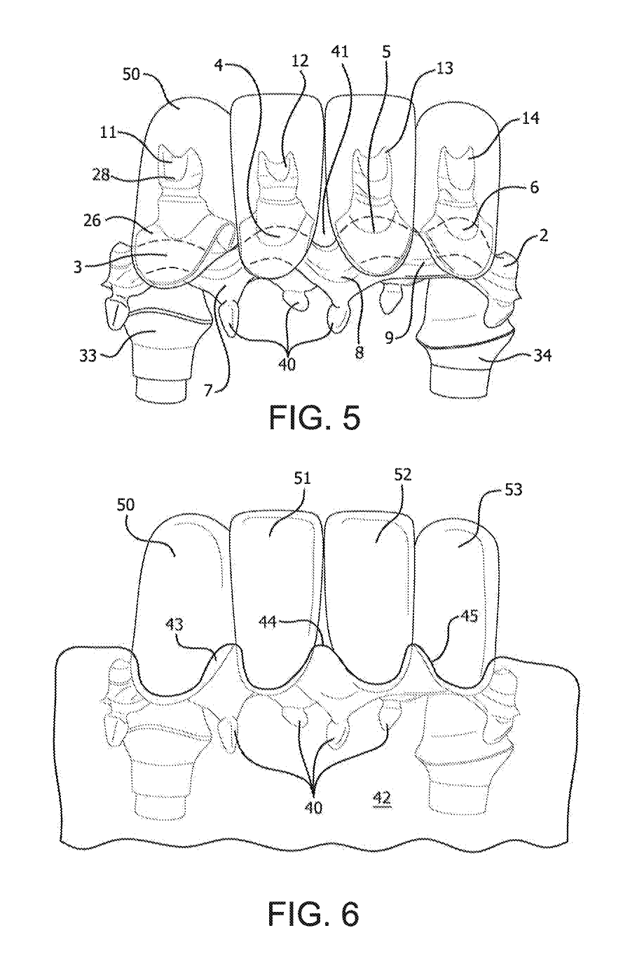

Dental framework 1 is an integral body comprising an elongated, serpentine shaped framework support 2 which extends substantially the full length of the framework. This configuration results in support 2 having a plurality of hills and valleys, or raised regions interconnected by lower regions. See, for example, raised regions 3, 4, 5, and 6 and lower regions 7, 8, and 9 in FIG. 5. This hills and valley configuration extends the length of framework support 2. It serves not only to strengthen dental framework 1, but also to greatly assist in the crown installation process.

Located over and being integral with or otherwise attached to each raised region of framework support 2 are a plurality of dental crown receiving abutments, i.e. incisor crown abutments 11, 12, 13, 1.4, 15 and 16, canine crown abutments 17, 18, 19, and 20, and molar crown abutments 21, 22, 23, and 24. Of course, it is contemplated that dental framework 1 will be custom designed and fabricated to accommodate individual patients, so the present invention is not to be considered restricted to the type and number of abutments described herein.

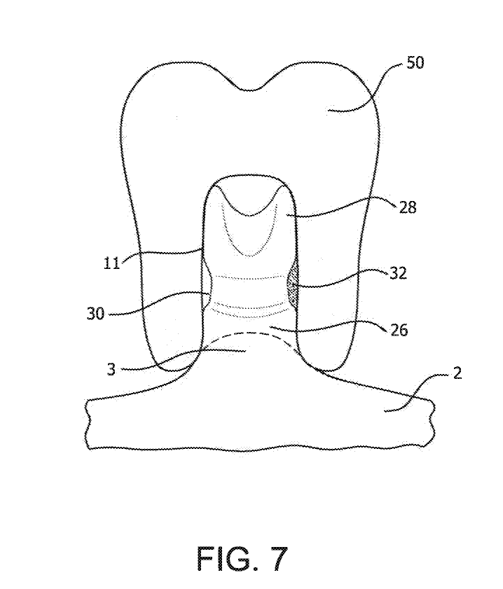

Regardless of their particular shape, each dental abutment comprises a lower section and an upper section. FIGS. 5 and 7 illustrate an exemplar abutment 11, with lower section 26 overlaying raised region 3.

As seen in detail in FIG. 7, again directed to exemplar abutment 11, the average diameter of lower section 26 is greater than the average diameter of the upper section 28. This unique design results in space 30 circumscribing abutment 11, between the abutment and dental crown 50, configured to be positioned over and secured to the abutment. This allows placement of adhesive 32 within space 30, to ensure a more permanent attachment of crown 50 to abutment 11. Each abutment, regardless of shape, is designed with a lower section with a larger average diameter than its upper section, to thus create an adhesive accepting space between the abutments and their respective crowns.

Implant supports 32, 33, 34, and 35, configured to be implanted into the alveolar bone beneath the gum in a patient, extend down from support 2. A plurality of composite attachment spikes 40 extend from the underside of support 2. These spikes are designed to be implanted into the gum composite material 42 which is used to surround dental framework 1, once it and appropriate dental crowns are installed on the abutments of framework support 2. Spikes 40 serve to secure and maintain dental framework 1 to the composite. FIG. 6 provides an example of the positioning of spikes 40 and the manner in which the spikes securely hold dental framework 1 in place within composite 42.

Also of note in FIG. 6 and also in FIG. 5, the configurations of the abutments result in the creation of spaces at the lower sections of adjacent abutments and, ultimately, the adjacent crowns. As exemplified in FIG. 5, space 41 is created between the lower areas of abutments 12 and 13 and, as seen in FIG. 6, composite 42 will enter and fill these spaces between adjacent crowns, e.g. at 43 between crowns 50 and 51, at 44 between crowns 51 and 52, and at 45 between crowns 52 and 53. This assists in securely maintaining the composite, as well as enhancing the overall appearance of the dental system.

Thus, dental framework 1 of the present invention provides a unique dental device with a number of significant features. It not only serves to more efficiently allow the dentist to effectively install a plurality crowns, but also guarantees the patient with an excellent result d appearance which will last for many years.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A dental framework to be implanted into alveolar bone beneath gum in an individual's mouth and for supporting dental crowns, said framework comprising:
an elongated, serpentine shaped framework support extending substantially the length of the framework, said framework support comprising a plurality of raised regions interconnected by a plurality of lower regions;
a plurality of crown supporting abutments, each abutment of said plurality being located on and being integral with or being attached to one of the plurality of raised regions, each said abutment further having a lower section of a given average diameter overlaying a raised region of the support bar and an upper section having a given average diameter less than the average diameter of the lower section extending upward from the lower section, whereby upon the placement of a dental crown over an abutment, there is a space between the abutment and the crown; and
a plurality of dental implant supports extending down from the framework support.

2. The dental framework as in claim 1 wherein adhesive is installed within the space between each abutment and their respective dental crown.

3. A dental framework to be implanted into alveolar bone beneath the gum in an individual's mouth and for supporting dental crowns, said framework comprising:
an elongated, serpentine shaped framework support extending substantially the length of the framework, said framework support comprising a plurality of raised regions interconnected by a plurality of lower regions;
a plurality of crown supporting abutments, each abutment of said plurality being located on and being integral with or being attached to one of the plurality of raised regions, each said abutment having a lower section overlaying a raised region of the support bar, whereby upon placement of a dental crown over each said abutment a space is created between the lower areas of adjacent abutments and their respective adjacent crowns; and
a plurality of dental implant supports extending down from the framework support.

4. The dental framework as in claim 3 wherein gum composite material is located within the spaces created between the lower areas of adjacent abutments and their respective adjacent crowns.

5. A dental framework to be implanted into alveolar bone beneath the gum in an individual's mouth and for supporting dental crowns, said framework comprising:
an elongated, serpentine shaped framework support extending substantially the length of the framework, said framework support comprising a plurality of raised regions interconnected by a plurality of lower regions;
a plurality of crown supporting abutments;
a plurality of dental implant supports extending down from the support bar; and
a plurality of composite attachment spikes extending down from the underside of the support bar.

6. The dental framework as in claim 1 further comprising a plurality of composite attachment spikes extending down from the underside of the support bar,

7. The dental framework as in claim 3 further comprising a plurality of composite attachment spikes extending down from the underside of the support bar.
